(19) United States
(12) Patent Application Publication
(10) Pub. No.: US 2010/0182428 A1
(43) Pub. Date: Jul. 22, 2010

(54) CENTRALIZED-CONTROLLED SURVEILLANCE SYSTEMS CAPABLE OF HANDLING MULTIPLE DATA STREAMS

(76) Inventors: Ching-Hung Lu, Taoyuan County (TW); Jia-Shiun Li, Tainan County (TW); Szu-Hsien Lee, Taipei City (TW); Shi-Shiuan Kao, Taipei City (TW); Chun-Chia Huang, Taichung City (TW)

Correspondence Address: NORTH AMERICA INTELLECTUAL PROPERTY CORPORATION, P.O. BOX 506, MERRIFIELD, VA, 22116, US

(21) Appl. No.: 12/356,071

(22) Filed: Jan. 19, 2009

(51) Int. Cl. H04N 7/18

(52) U.S. Cl. 348/143; 348/E07.085

(57) ABSTRACT

A surveillance system including a plurality of network video recorders (NVRs), a plurality of network video capturing devices and a plurality of streaming media presentation devices (SMPDs) is provided. The NVRs can receive and store digitized data packets, as well as transmit video/audio streams, event notifications, authorization codes and control signals. The network video capturing devices, each connected to a corresponding NVR among the plurality of NVRs via a network, can capture video/audio data and providing the digitized data packets by encoding the captured video/audio data. The SMPDs are connected to the plurality of NVRs via the network and can play captured video/audio data and alerting messages associated with the event notifications.

### BACKGROUND OF THE INVENTION

1. Field of the Invention

The present invention is related to a surveillance system, and more particularly, to a centralized-controlled surveillance system capable of handling multiple data streams.

2. Description of the Prior Art

Surveillance systems are widely used in various occasions for security purpose. Reference is made to FIG. 1 for a diagram illustrating a traditional analog surveillance system 10. The analog surveillance system 10 supports multiple analog cameras designed to transmit standard television input signals, such as those defined by the National Television System Committee (NTSC) in 1953. The analog cameras are connected to a time lapse video cassette recorder (VCR) 16, which in turn is connected a viewing device 18. The analog surveillance system 10 is a closed loop system where video/audio data does not migrate outside the site where the system resides. Traditional analog surveillance systems require deployment of a complex network of coaxial cables or fiber cables. Expensive trenching may be required to lay the cables if the analog cameras are somewhat distant from the monitoring station. Not only is a large storage room needed for housing the archives of videotapes, reviewing historical video is time-consuming and tedious, and the quality of the archive does not last over the long haul.

The rapid development of video compression algorithms (such as JPEG, MJPEG, MPEG-4, etc.), improvement in computer processing speeds and a rapid reduction in data storage costs then give rise to the digital video recorder (DVR) technology. Reference is made to FIG. 2 for a diagram illustrating a prior art digital surveillance system 20. In the digital surveillance system 20, the viewing device 18 is plugged into a DVR 26, which takes analog video/audio feeds from all the cameras 12. By timesharing analog video/audio streams, the DVR 26 converts each output from the cameras to packets of digitized video/audio data and stores the now digitized video/audio data on a hard drive that may be internal to the DVR 26 itself. The prior art digital surveillance system 20 provides non-linear access to recorded material usually selected by camera ID, time and date. The consistency of quality of recorded material will in general be higher than that obtained with analog tapes. However, DVR surveillance systems still have several limitations during use, such as distribution engineering and data reliability issues.

As the Internet becomes more and more widespread, network video recorders (NVRs) and digital Internet Protocol (IP) cameras have been developed for surveillance systems. Reference is made to FIG. 3 for a diagram illustrating a prior art NVR surveillance system 30. In the NVR surveillance system 30, a plurality of digital IP cameras #1-#n are connected to an NVR 36 via a network. The NVR 36 directly receives digitized video/audio packets that have already been encoded at the digital IP cameras #1-#n. The viewing device 18 is plugged into a PC 38, which is also connected to the NVR 36 for receiving and processing video/audio data.

Conventional NVR surveillance systems have several shortcomings. A typical NVR is only suitable for use as a storage device, but not for use as the monitoring purposes because it does not support a real-time monitoring and playback function. Therefore, conventional NVR surveillance systems require PC-based software solutions, which not only have high hardware and software costs, but are also limited by operating system stability. The conventional PC operating system requires a lengthy start-up sequence and complicated software controls, and may not be able to handle multiple video/audio decoding, such as viewing data of 4 IP cameras simultaneously. An NVR with built-in real-time viewing ability has limited system extensibility, which, for instance, can only output data to one monitor. Summary of the Invention

The present invention provides a centralized-controlled surveillance system capable of handling multiple data streams, comprising a network video recorder (NVR) capable of receiving and storing digitized data packets, as well as transmitting video/audio streams, event notifications, authorization codes and control signals; a plurality of network video capturing devices connected to the NVR via a network and capable of capturing video/audio data and providing the digitized data packets by encoding the captured video/audio data; and a plurality of streaming media presentation devices (SMPDs) each connected to the NVR via the network and capable of playing captured video/audio data and an alerting message associated with an event notification.

The present invention also provides a centralized-controlled surveillance system capable of handling multiple data streams, comprising a plurality of NVRs capable of receiving and storing digitized data packets, as well as transmitting video/audio streams, event notifications, authorization codes and control signals; a plurality of network video capturing devices each connected to a corresponding NVR among the plurality of NVRs via a network and capable of capturing video/audio data and providing the digitized data packets by encoding the captured video/audio data; and a plurality of SMPDs connected to the plurality of NVRs via the network and each capable of playing captured video/audio data and an alerting message associated with an event notification.

The present invention also provides a method for configuring an SMPD using an NVR in a surveillance system, comprising setting an NVR as a configuring NVR; determining whether the configuring NVR can acquire a management privilege from an SMPD to be configured; modifying a configuration of the SMPD to be configured if the configuring NVR can acquire the management privilege; determining whether a slave NVR associated with the configuring NVR can be obtained if the configuring NVR cannot acquire the management privilege; pushing the configuring NVR to a stack and setting the associated slave NVR as the current configuring NVR if the associated slave NVR can be obtained; determining whether an NVR exists in the stack if the associated slave NVR cannot be obtained; and popping the stacked NVR from the stack and setting the stacked NVR as the current configuring NVR if the stacked NVR can be obtained.

The present invention also provides a method for configuring an NVR in a surveillance system, comprising determining if a master NVR can acquire a management privilege from a selected NVR; determining whether adding the selected NVR to a management list of the master NVR results in a loop; and adding the selected NVR to the management list of the master NVR if the management privilege can be acquired and adding the selected NVR to the management list of the master NVR does not result in a loop.

The present invention also provides a method for sending requests in a surveillance system, comprising an SMPD sending a request to an associated NVR; and the associated NVR operating based on the request and providing a feedback message.

The present invention also provides a method for performing event notifications in a surveillance system, comprising an NVR storing video/audio data captured by a network video capturing device maintained by the NVR when triggered by a predetermined event; the NVR locating an SMPD associated with the triggered predetermined event; the NVR sending the stored video/audio data and an event notification associated with the triggered predetermined event to the associated SMPD; and the associated SMPD executing corresponding functions for highlighting the triggered predetermined event.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a traditional analog surveillance system.

FIG. 2 is a diagram illustrating a traditional digital surveillance system.

FIG. 3 is a diagram illustrating a prior art NVR surveillance system.

FIGS. 4 and 5 are diagrams illustrating exemplary configurations of surveillance systems according to the present invention.

FIG. 6 is a diagram showing exemplary configurations of the network video capturing devices according to the present invention.

FIG. 7 is a diagram showing an exemplary configuration of an SMPD according to the present invention.

FIG. 8 is a flowchart illustrating a configuration procedure of the management list of an NVR according to the present invention.

FIG. 9 is a flowchart illustrating a configuration procedure of an SMPD according to the present invention.

FIG. 10 is a flowchart illustrating a request-sending procedure of the SMPD according to the present invention.

FIG. 11 is a flowchart illustrating an event notification procedure of an SMPD according to the present invention.

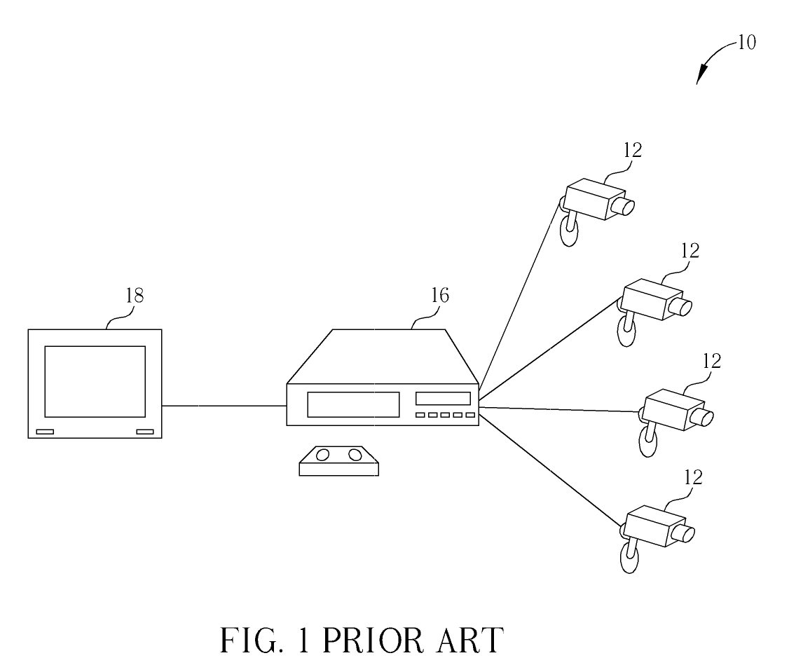

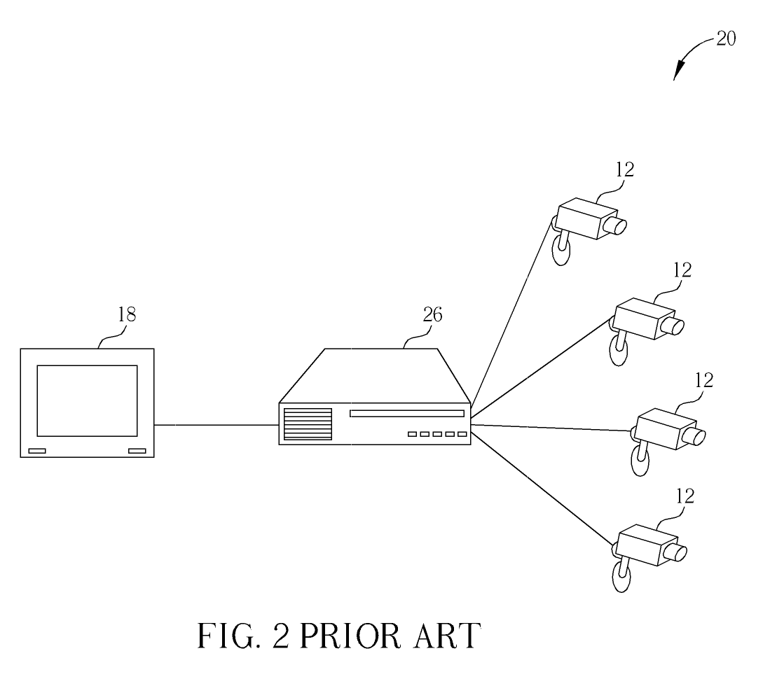

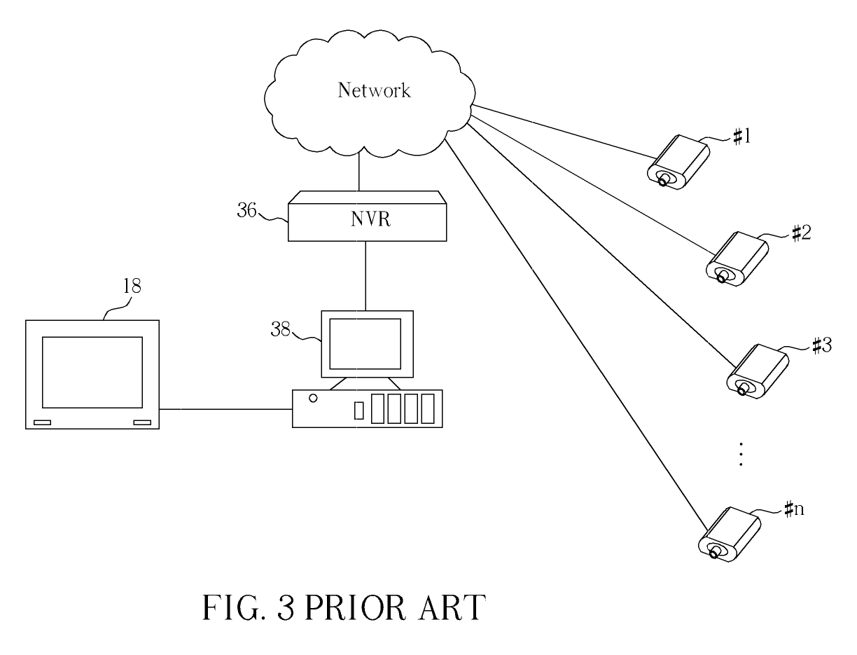

### DETAILED DESCRIPTION

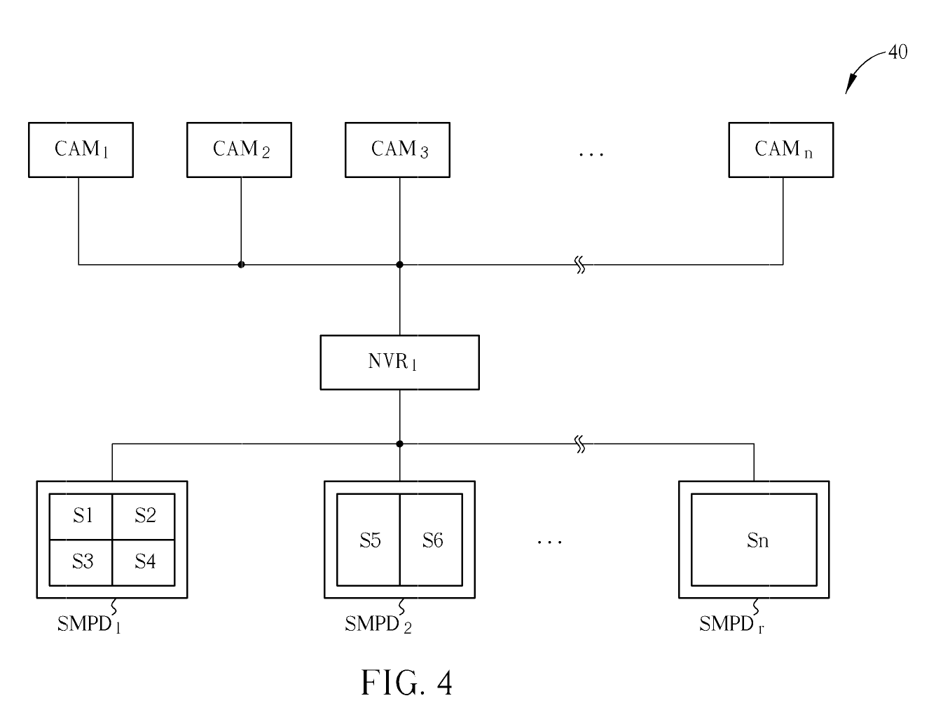

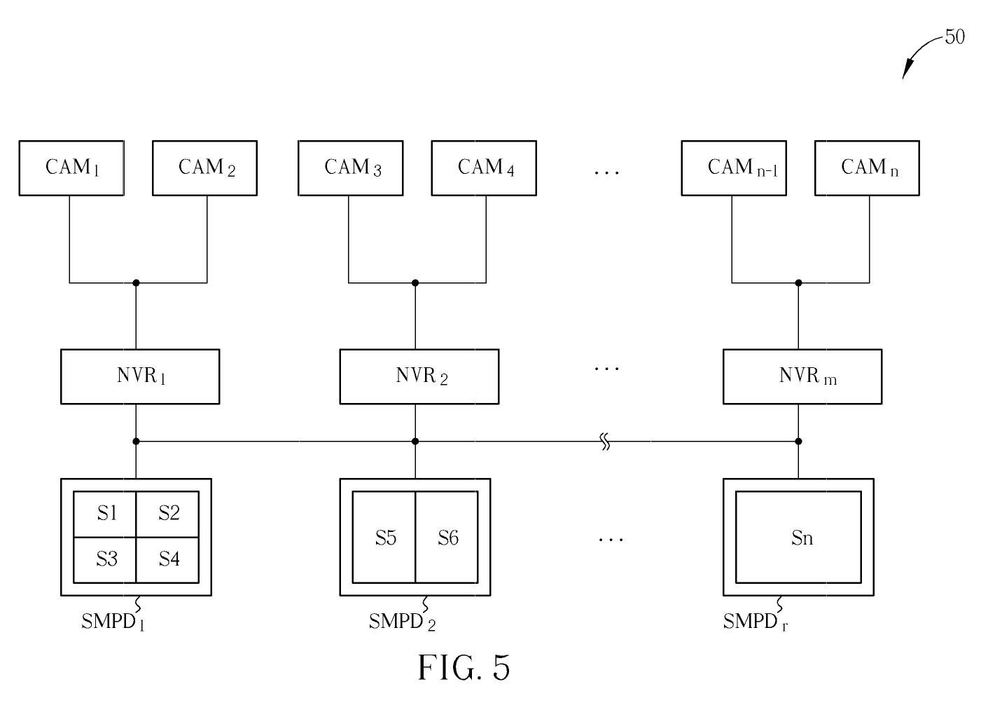

References are made to FIGS. 4 and 5 for diagrams illustrating exemplary configurations of surveillance systems 40 and 50 according to the present invention. In a first embodiment of the present invention depicted in FIG. 4, the surveillance system 40 includes a plurality of network video capturing devices CAM₁-CAMₙ, a network video recorder NVR₁ and a plurality of streaming media presentation device (SMPDs) SMPD₁-SMPDᵣ. In a second embodiment of the present invention depicted in FIG. 5, the surveillance system 50 includes a plurality of network video capturing devices CAM₁-CAMₙ, a plurality of network video recorders NVR₁-NVRₘ, and a plurality of streaming media presentation device SMPD₁-SMPDᵣ.

Data transmission within the surveillance system 40 is performed based on a network, via which the NRV₁ receives digitized video/audio packets from the network video capturing devices CAM₁-CAMₙ, and sends video/audio streams, event notifications, authorization codes or control signals to the SMPD₁-SMPDᵣ. Based on user requests, each of the SMPD₁-SMPDᵣ can be configured, play video/audio data captured by one or multiple network video capturing devices simultaneously, or display alerting messages. For example, the SMPD₁ can play the video/audio data captured by CAM₁-CAM₄ simultaneously (as represented by S1-S4 in FIG. 4), the SMPD₂ can play the video/audio data captured by CAM₅ and CAM₆ (as represented by S5 and S6 in FIG. 4) simultaneously, and the SMPDᵣ can play the video/audio captured by CAM_{N} (as represented by Sn in FIG. 4).

Data transmission within the surveillance system 50 is also performed based on a network, via which the plurality of NVR₁-NVRₘ receive digitized video/audio packets from corresponding network video capturing devices CAM₁-CAMₙ, and send video/audio streams, event notifications, authorization codes or control signals to corresponding SMPD₁-SMPDᵣ. Based on user requests, each of the SMPD₁-SMPDᵣ can be configured, play video/audio data captured by one or multiple network video capturing devices simultaneously, or display alerting messages. For example, the SMPD₁ can play the video/audio data captured by CAM₁-CAM₄ simultaneously (represented by S1-S4), the SMPD₂ can play the video/audio data captured by CAM₅ and CAM₆ (represented by S5 and S6) simultaneously, and the SMPDᵣ can play the video/audio data captured by CAM_{N} (represented by Sn). In the surveillance system 50, each of NVR₁-NVRₘ can be associated with two network video capturing devices (as shown in FIG. 5), or to more network video capturing devices in other applications.

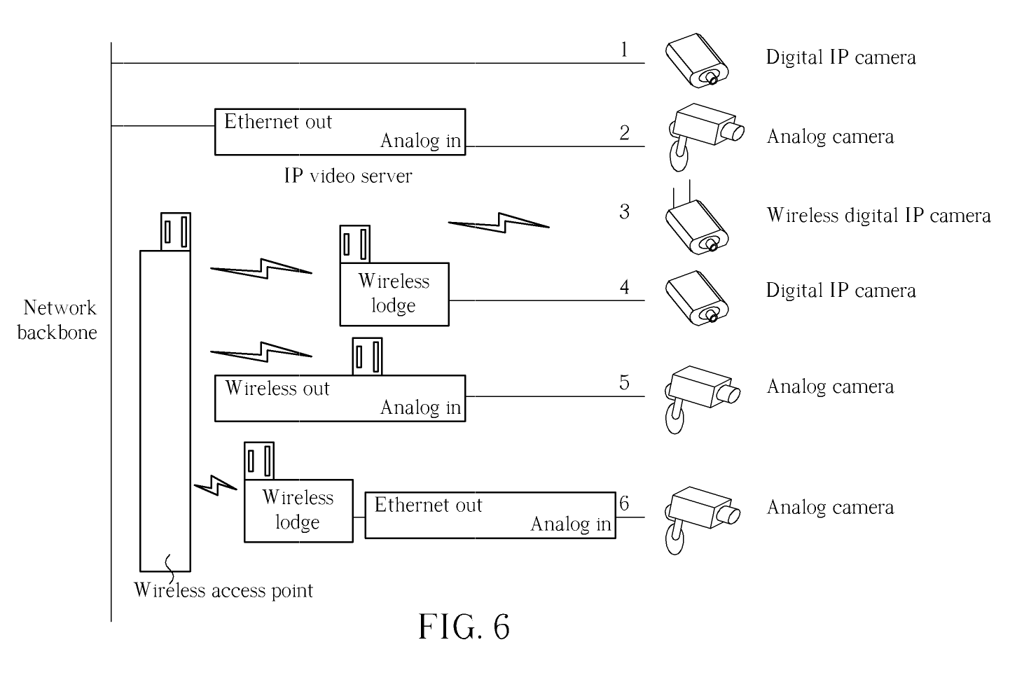

Reference is made to FIG. 6 for a diagram showing exemplary configurations of the network video capturing devices in FIGS. 4 and 5. In the first configuration, a digital IP camera is physically connected to the network. In the second configuration, an analog camera is connected to a video server (capable of converting analog video/audio data to digital video/audio data) and thus can deliver IP video/audio data across the network. In the third configuration, a digital IP camera with a built in wireless transmitter is provided so as to commute with a device such as a wireless access point, thereby physically connected to the network. In the fourth configuration, a digital IP camera is physically connected to the network via a wireless Ethernet lodge. In the fifth configuration, a wireless video server capable of communicating with a wireless receiver such as an access point is provided so as to physically connect an analog camera to the network. In the sixth configuration, both a wireless Ethernet lodge and a wired Ethernet video server are employed for physically connecting an analog camera to the network. The network video capturing devices illustrated in FIG. 6 are only exemplary configurations and do not limit the scope of the present invention. The surveillance systems according to the present invention can also use other types of network video capturing devices having network ability.

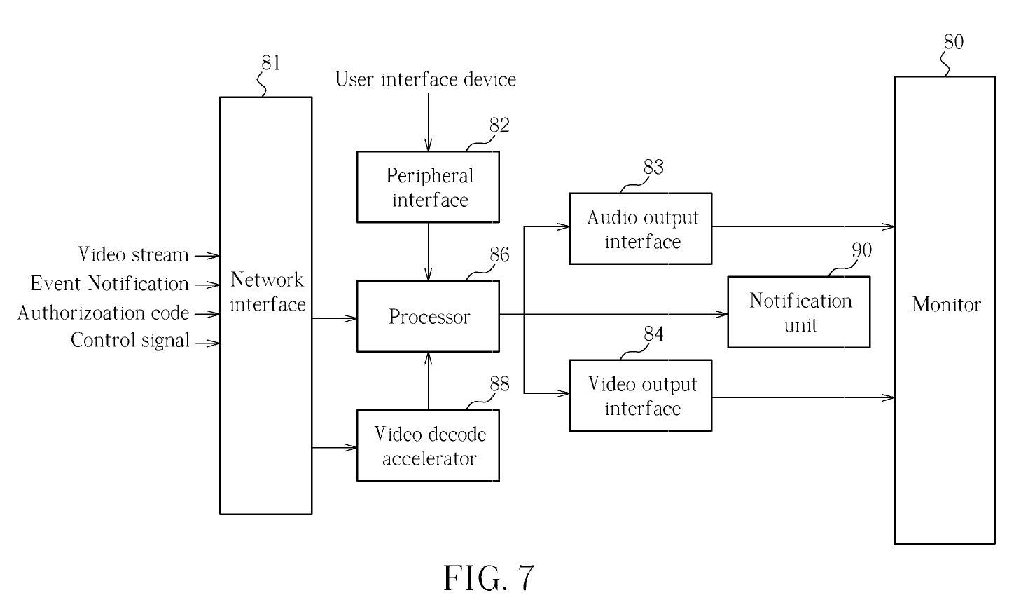

Reference is made to FIG. 7 for a diagram showing an exemplary configuration of an SMPD in FIGS. 4 and 5. The SMPD includes a plurality of interfaces 81-84, a processor 86, a video decode accelerator 88, a notification unit 90, and a monitor 80. The processor 86 can include a general-purpose processor (GPP) capable of executing primitive or low-level operations (such as add, multiply, subtract, compare, load, store) which can be sequenced into a programmed set of instructions (software program) to implement a complex function. The video decode accelerator 88 can include low-power and high-efficiency devices capable of supporting multiple video/audio streams and accelerating certain applications of the processor, such as an application-specific integrated circuit (ASIC), a specific SOC system, or a digital signal processor (DSP). Via the network interface 81, the SMPD can receive signals from the NVR, such as video/audio streams, event notifications, authorization codes or control signals. User interface devices, such as universal serial buses (USBs) or portable hard drives, can be electrically connected to the SMPD via the peripheral interface 82. Via the audio output interface 83 and the video output interface 84, audio data and video data can be respectively outputted to the monitor 80 for broadcasting video/audio data or alerting messages associated with event notifications. The notification unit 90 can be used for playing alerting messages associated with event notifications. The monitor 80 can be integral to the SMPD, or a standalone device. The notification unit 90 can inform the user of an event notification by means of visual messages, such as by an light emitting diode (LED) capable of sparkling upon receiving an alerting message, or by means of audio messages, such as by a beep device. The SMPD can be centrally controlled by a host having network ability, such as an NVR or a PC. Between the host and the SMPD, video/audio streams, event notifications, authorization codes or control signals can be transmitted via the network interface 81. This way, the need to plug/unplug video connector when changing video source is reduced, and the surveillance systems 40 and 50 can switch visible video streams through different configurations easily.

In the present invention, each SMPD only relates to an NVR, while an NVR can relate to one or multiple SMPDs in terms of accessing configuration data. To be more precise, the configuration data can only be written into an SMPD via its corresponding NVR. If the NVR₁ is the master NVR of the NVR₂ to which the SMPD₂ is related, the NVR₁ needs to send a request to the NVR₂ for writing the configuration data into the SMPD₂, instead of directly writing the configuration data into the SMPD₂. Each SMPD in the present invention can employ a hardware lock so that only an NVR can be configured to associate with an SMPD while the hardware lock is disabled.

Each NVR in FIGS. 4 and 5 includes a management list containing one or multiple NVRs. In regard of the same management list, the owner of the management list is referred to as a master NVR, while an NVR on the management list is referred to as a slave NVR. A master NVR owns the authorization to manage its slave NVR(s). Referring to the surveillance system 50 according to the second embodiment of the present invention for illustration, the video/audio data captured by different network video capturing devices are stored in different NVRs. For example, the network video capturing devices CAM₁ and CAM₂ are directly maintained by the NVR₁, while the network video capturing devices CAM₃ and CAM₄ are directly maintained by the NVR₂. If the NVR₂ is included in the management list of the NVR₁, then the SMPDs maintained by the master NVR₁ can be configured to associate with the network video capturing devices CAM₃ and CAM₄ maintained by the slave NVR₂.

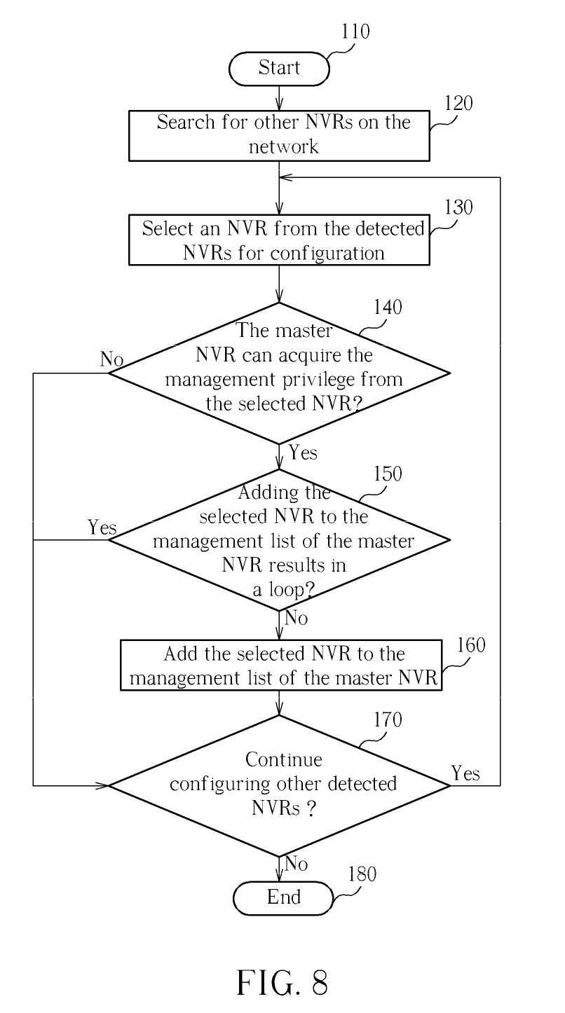

A master NVR can also be a slave NVR of other master NVR(s). Therefore, an undesirable “loop” occurs when, for instance, the NVR₁ is the slave NVR of the NVR₂, the NVR₂ is the slave NVR of the NVR₃, and the NVR₃ is the slave NVR of the NVR₁. To avoid this, the management list of an NVR must be properly configured before operations. Reference is made to FIG. 8 for a flowchart illustrating a configuration procedure of the management list of an NVR according to the present invention. The flowchart in FIG. 8, performed by a master NVR to be configured, includes the following steps:

Step 110: start;

Step 120: search for other NVRs on the network;

Step 130: select an NVR from the detected NVRs for configuration;

Step 140: determine if the master NVR can acquire the management privilege from the selected NVR; if the master NVR can acquire the management privilege from the selected NVR, execute step 150; if the master NVR cannot acquire the management privilege from the selected NVR, execute step 170;

Step 150: determine whether adding the selected NVR to the management list of the master NVR results in a loop; if adding the selected NVR results in a loop, execute step 170; if adding the selected NVR does not result in a loop, execute step 160;

Step 160: add the selected NVR to the management list of the master NVR;

Step 170: determine if it is required to continue configuring other detected NVRs; if it is required to continue configuring other detected NVRs, executed step 130; if it is not required to continue configuring other detected NVRs, executed step 180;

Step 180: end.

The management privilege mentioned in step 140 can be acquired if the selected NVR allows the master NVR to perform management. An account and a password can be used, as well as other authorization methods. For example, if the correct account and password are provided, an authorization code can be issued for granting the management privilege mentioned in step 140.

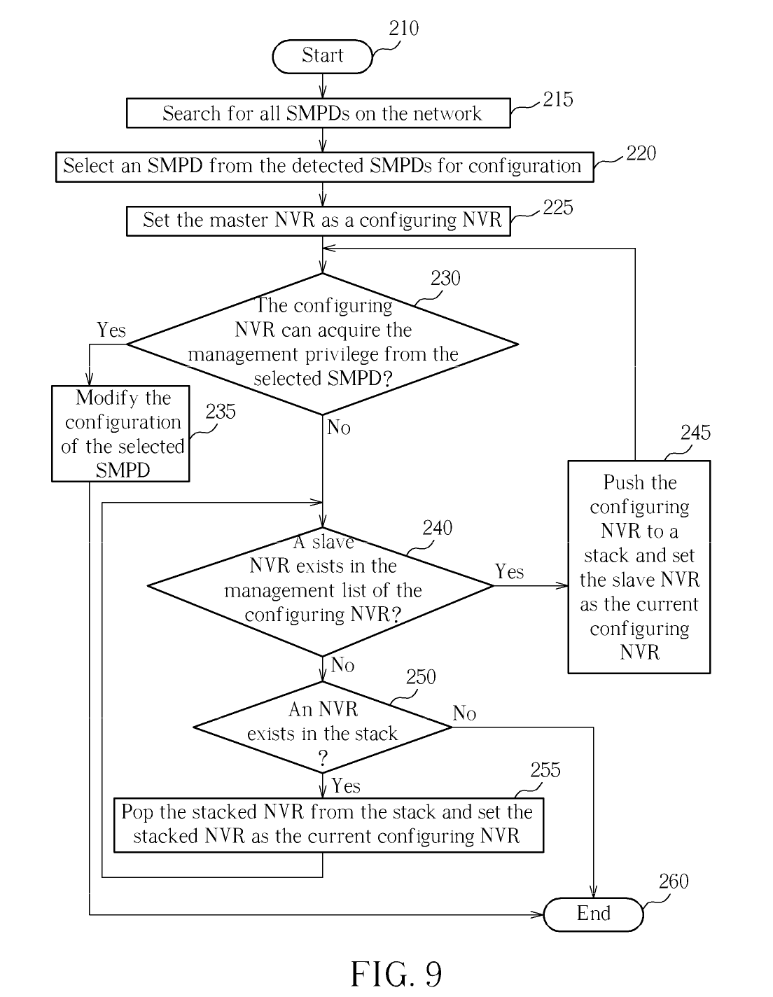

As mentioned before, each SMPD only relates to an NVR, while an NVR can relate to one or multiple SMPDs in the present invention. If the SMPD₂ is only related to the NVR₂ in the default setting (as depicted in FIG. 5), the NVR₁ is not authorized to manage the SMPD₂. However, once the NVR₁ becomes the master NVR of the NVR₂ after the configuration process in steps 110-180, the master NVR₁ can control the SMPD₂ via the slave NVR₂. Reference is made to FIG. 9 for a flowchart illustrating a configuration procedure of an SMPD according to the present invention. The flowchart in FIG. 9, performed by a master NVR, includes the following steps:

Step 210: start;

Step 215: search for all SMPDs on the network;

Step 220: select an SMPD from the detected SMPDs for configuration;

Step 225: set the master NVR as a configuring NVR;

Step 230: determine if the configuring NVR can acquire the management privilege from the selected SMPD; if the configuring NVR can acquire the management privilege from the selected SMPD, execute step 235; if the configuring NVR cannot acquire the management privilege from the selected SMPD, execute step 240;

Step 235: modify the configuration of the selected SMPD; execute step 260;

Step 240: determine if a slave NVR exists in the management list of the configuring NVR; if the slave NVR exists, execute step 245; if the slave NVR does not exist, execute step 250;

Step 245: push the configuring NVR to a stack and set the slave NVR as the current configuring NVR; execute 230;

Step 250: determine if an NVR exists in the stack; if a stacked NVR exists, execute step 255; if a stacked NVR does not exist, execute step 260;

Step 255: pop the stacked NVR from the stack and set the stacked NVR as the current configuring NVR; execute 240;

Step 260: end.

The flowchart in FIG. 9 illustrates the concept of centralized control in the surveillance systems according to the present invention. The management privilege mentioned in step 230 can be acquired if the configuring NVR is authorized to write the configuration data into the selected SMPD. After selecting an SMPD to be configured, the master NVR can modify the configuration directly when able to acquire the management privilege from the selected SMPD, as illustrated in step 235. When unable to acquire the management privilege from the selected SMPD, the master NVR can try to configure the selected SMPD via its slave NVRs and even via the NVRs included in the management list of a slave NVR.

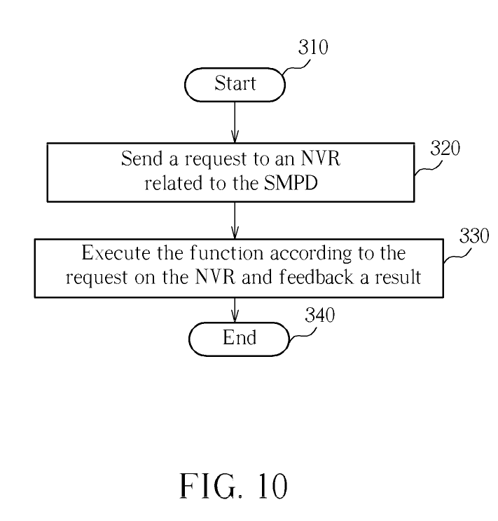

Once successfully configured, an SMPD can send various requests to its corresponding NVR. Reference is made to FIG. 10 for a flowchart illustrating a request -sending procedure of the SMPD according to the present invention. The flowchart in FIG. 10, performed by an SMPD, includes the following steps:

Step 310: start;

Step 320: send a request to an NVR related to the SMPD;

Step 330: execute the function according to the request on the NVR and feedback a result;

Step 340: end.

The request sent in step 320 can include a request for live-viewing, recorded video list, transmitting video/audio streams, taking snapshots or performing compelling recording . . . etc. For example, in the live-viewing application, the SMPD first searches in its configuration data for the corresponding NVR after start-up. Next, the SMPD sends a request requiring the NVR to provide associated configuration data, such as the IP address of an IP camera. Then, the SMPD sends a request requiring the NVR to transmit video/audio streams captured by the corresponding IP camera for live-viewing. Or, the SMPD can request the NVR to provide all available recorded video/audio data. Upon receiving the request, the NVR can either provide a playback list including all available recorded video/audio data for user selection, or feedback a trouble-shooting message if the SMPD somehow fails to log in to the NVR.

An NVR receives captured video/audio data from all associated network video capturing devices continuously, but only starts recording video/audio data when triggered by predetermined events or criteria, such as moving objects or daylight. However, the user can order a non-recording NVR to work by giving a correspond request in step 320, such as instructing the NVR to record the current event immediately or taking snapshots of the current video in step 330.

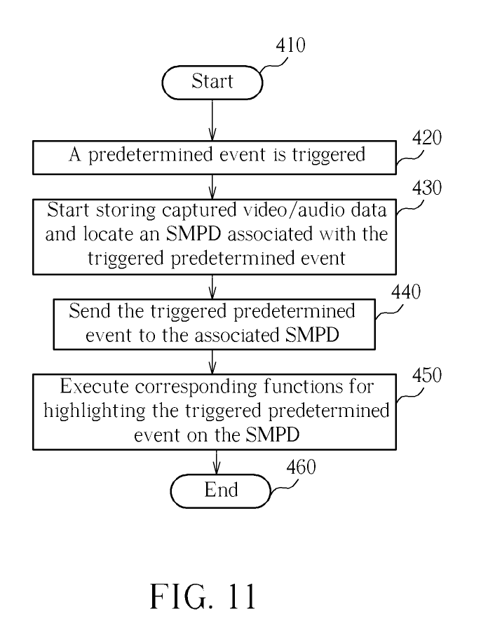

In the present invention, an NVR can also send event notifications to an SMPD for highlighting certain events. Reference is made to FIG. 11 for a flowchart illustrating an event notification procedure of an SMPD according to the present invention. The flowchart in FIG. 11, performed by an NVR includes the following steps:

Step 410: start;

Step 420: a predetermined event is triggered

Step 430: start storing captured video/audio data and locate an SMPD associated with the triggered predetermined event;

Step 440: send the triggered predetermined event to the associated SMPD;

Step 450: execute corresponding functions for highlighting the triggered predetermined event on the SMPD;

Step 460: end.

Once triggered by predetermined events or criteria, the NVR begins storing the video/audio data captured by the associated network video capturing device in step 420. A notification message is sent to the associated SMPD in step 440 for informing the triggered predetermined event. Upon receiving the notification message in step 450, the associated SMPD can execute corresponding functions for highlighting the triggered predetermined event. For example, a previously dormant monitor can exit standby mode for displaying the recorded video/audio data or an alerting message regarding the triggered predetermined event. The alerting message can be played using the notification unit 90 in FIG. 7 (such as sparkles of an LED or the sounds of a beep device), or displayed as text message on the screen 80 together with the recorded video/audio data. The SMPD can also zoom in on the recorded video for highlighting the triggered predetermined event.

In the surveillance systems according to the present invention, a dedicated, low-cost and low power SMPD is utilized instead of an expensive PC as in conventional NVR surveillance systems. The SMPDs can be disposed at various locations for vast monitoring, while centrally controlled by a host having networking ability. Based on data received from the host, an SMPD can play a captured video/audio data, enlarge the captured video, wake up the screen or display an alerting message using the notification unit. The SMPD can also send request to the host for performing certain operations, such as recording the current event immediately or taking snapshots of the current video.

Those skilled in the art will readily observe that numerous modifications and alterations of the device and method may be made while retaining the teachings of the invention.

What is claimed is:

1. A centralized-controlled surveillance system capable of handling multiple data streams, comprising:
a network video recorder (NVR) capable of receiving and storing digitized data packets, as well as transmitting video/audio streams, event notifications, authorization codes and control signals;
a plurality of network video capturing devices connected to the NVR via a network and capable of capturing video/audio data and providing the digitized data packets by encoding the captured video/audio data; and
a plurality of streaming media presentation devices (SMPDs) each connected to the NVR via the network and capable of playing captured video/audio data and an alerting message associated with an event notification.

2. The surveillance system of claim 1 wherein each SMPD comprises:
a processor for processing the video/audio streams received from the NVR; and
a video decode accelerator for increasing a speed of the processor.

3. The surveillance system of claim 1 wherein each SMPD comprises:
a network interface for transmitting the video/audio streams received from the NVR;
a user interface for transmitting user requests; and
an output interface for transmitting video/audio data.

4. The surveillance system of claim 1 wherein each SMPD comprises:
a monitor for playing the captured video data correspond to the received video streams or the alerting message corresponding to the received event notification.

5. The surveillance system of claim 1 wherein each SMPD comprises:
a notification unit for playing the alerting message corresponding to the received event notification.

6. The surveillance system of claim 1 wherein the plurality of network video capturing devices include Internet Protocol (IP) cameras.

7. A centralized-controlled surveillance system capable of handling multiple data streams, comprising:
a plurality of NVRs capable of receiving and storing digitized data packets, as well as transmitting video/audio streams, event notifications, authorization codes and control signals;
a plurality of network video capturing devices each connected to a corresponding NVR among the plurality of NVRs via a network and capable of capturing video/audio data and providing the digitized data packets by encoding the captured video/audio data; and
a plurality of SMPDs connected to the plurality of NVRs via the network and each capable of playing the captured video/audio data and an alerting message associated with an event notification.

8. The surveillance system of claim 7 wherein each SMPD comprises:
a processor for processing the video/audio streams received from the plurality of NVRs; and
a video decode accelerator for increasing a speed of the processor.

9. The surveillance system of claim 7 wherein each SMPD comprises:
a network interface for transmitting the video/audio streams received from the plurality of NVRs;
a user interface for transmitting user requests; and
an output interface for transmitting the video/audio data.

10. The surveillance system of claim 7 wherein each SMPD comprises:
a monitor for playing the captured video/audio data correspond to the received video/audio streams or the alerting message corresponding to the received event notification.

11. The surveillance system of claim 7 wherein each SMPD comprises:
a notification unit for playing the alerting message corresponding to the received event notification.

12. The surveillance system of claim 7 wherein the plurality of network video capturing devices include IP cameras.

13. A method for configuring an SMPD using an NVR in a surveillance system, comprising:
setting an NVR as a configuring NVR;
determining whether the configuring NVR can acquire a management privilege from an SMPD to be configured;
modifying a configuration of the SMPD to be configured if the configuring NVR can acquire the management privilege;
determining whether a slave NVR associated with the configuring NVR can be obtained if the configuring NVR cannot acquire the management privilege;
pushing the configuring NVR to a stack and setting the associated slave NVR as the current configuring NVR if the associated slave NVR can be obtained;
determining whether an NVR exists in the stack if the associated slave NVR cannot be obtained; and
popping the stacked NVR from the stack and setting the stacked NVR as the current configuring NVR if the stacked NVR can be obtained.

14. The method of claim 13 further comprising:
psearching for all SMPDs on a network; and
selecting the SMPD to be configured from the detected SMPDs.

15. A method for configuring an NVR in a surveillance system, comprising:
determining if a master NVR can acquire a management privilege from a selected NVR;
determining whether adding the selected NVR to a management list of the master NVR results in a loop; and
adding the selected NVR to the management list of the master NVR if the management privilege can be acquired and adding the selected NVR to the management list of the master NVR does not result in a loop.

16. The method of claim 15 further comprising:
searching for all NVRs on a network; and
acquiring the selected NVR from the detected NVRs.

17. A method for sending requests in a surveillance system, comprising:
an SMPD sending a request to an associated NVR; and
the associated NVR operating based on the request and providing a feedback message.

18. A method for performing event notifications in a surveillance system, comprising:
an NVR storing video/audio data captured by a network video capturing device maintained by the NVR when triggered by a predetermined event;
the NVR locating an SMPD associated with the triggered predetermined event;
the NVR sending the stored video/audio data and an event notification associated with the triggered predetermined event to the associated SMPD; and
the associated SMPD executing corresponding functions for highlighting the triggered predetermined event.

19. The method of claim 18 further comprising:
a monitor exiting standby mode for playing the stored video/audio data or an alerting message associated with the event notification.

20. The method of claim 18 further comprising:
highlighting the triggered predetermined event by enlarging the stored video.
